(19) United States
(12) Patent Application Publication
(10) Pub. No.: US 2005/0208829 A1
(43) Pub. Date: Sep. 22, 2005

(54) Moldable cable termination system

(76) Inventor: Richard V. Campbell, Tallahassee, FL (US)

Correspondence Address: J. WILEY HORTON, ESQUIRE;Pennington, Moore, Wilkinson, Bell & Dunbar, P.A., Post Office Box 10095, Tallahassee, FL, 32302-2095, US

(21) Appl. No.: 11/018,446

(22) Filed: Dec. 21, 2004

Related U.S. Application Data
(63) Continuation-in-part of application No. 10/805,749, filed on Mar. 22, 2004.

(51) Int. Cl. H01R 13/40

(52) U.S. Cl. 439/587

(57) ABSTRACT

A process for creating a termination on a cable. A potting process is used to efficiently attach a cable's strands to a shell. A molding process is then used to mold a completed anchor over the shell (or otherwise attach the anchor to the shell), thereby forming a completed termination. In some embodiments the shell is omitted. For these versions the potting process is carried out in a first mold. The potted strands are then removed from this first mold and placed in a second mold, where molding compound is placed around the solidified potted region and allowed to harden to form a completed termination.

### CROSS-REFERENCES TO RELATED APPLICATIONS

This application is a continuation in part of U.S. application Ser. No. 10/805,749. The earlier application listed the same inventor. It was filed on Mar. 22, 2004.

### STATEMENT REGARDING FEDERALLY SPONSORED RESEARCH OR DEVELOPMENT

Not Applicable.

### MICROFICHE APPENDIX

Not Applicable

### BACKGROUND OF THE INVENTION

1. Field of the Invention

This invention relates to the field of synthetic cables and ropes. More specifically, the invention comprises a method for affixing an anchor to the end of a synthetic cable in order to form a highly-efficient termination, along with devices for carrying out the method.

2. Description of the Related Art

Devices for mounting a termination on the end of a wire, rope, or cable are disclosed in detail in copending U.S. Application Ser. No. 60/404,973 to Campbell, which is incorporated herein by reference.

The individual components of a wire rope are generally referred to as “strands,” whereas the individual components of synthetic cables are generally referred to as “fibers.” For purposes of this application, the term “strands” will be used generically to refer to the strands or fibers in a synthetic cable.

Cables must generally be attached to some type of load-bearing fitting in order to transmit a tensile load. This load-bearing fitting will be generically referred to as an “anchor.” The anchor is attached to the strands (typically on an end of the cable, but sometimes at an intermediate point). Once the strands are attached to the anchor, the anchor and the encompassed strands are collectively referred to as a “termination.”

It is known to create a termination by infusing the strands proximate an end of a cable with liquid potting compound. Some time prior to the liquid potting compound hardening, the strands are placed in an internal passage within an anchor (Note that the strands may be placed within the passage prior to infusing them with liquid potting compound). The liquid potting compound is then allowed to harden in place. The anchor's internal passage usually has an expanding shape, so that the solidified potting compound locks into the anchor. This process is generally referred to as “potting.”

The prior art contains many examples of potting. The term “potting” means infusing the exposed strands of a cable with a liquid potting compound which seeps between the strands and completely infuses a region of the cable. The liquid potting compound then transitions to a solid while still infused within the strands, creating a “solidified potted region.” Within the solidified potted region, the solidified potting compound is locked to the strands. The solidified potting compound does not extend outward significantly beyond the strands themselves. In other words, most all of the solidified potted region is a composite structure made up of cable strands and solidified potting compound. Only a relatively small region around the periphery possibly contains no strands.

The prior art also contains examples of molding an anchor directly onto the end of a cable. A mold cavity is placed around the dry strands, and a suitable molding compound is then used to fill the mold. Suitable molding compounds include reactive cross-linking polymers and, less commonly, thermoplastics.

Terminations formed by this molding approach have not performed particularly well, however. They are said to be inefficient. When applied to the field of cable terminations, the term “efficiency” refers to the mechanical properties of the completed termination. An “efficient” termination is one in which the stress required to break the completed cable assembly is almost as great as the stress required to break an individual strand within the cable itself. The term “efficiency” can refer to other mechanical properties as well, such as fatigue resistance. Again, an “efficient” cable is one in which the fatigue resistance of the completed cable assembly approaches that of an individual strand within the cable itself.

Those skilled in the art will know that a completed cable assembly will not be 100% efficient. As an example, if the constituent strands of a cable assembly can withstand a tensile stress of 200,000 psi, then the assembly as a whole would fail at a lower stress. The cable designer generally seeks to push the completed cable assembly's tensile strength as close as possible to the tensile strength of the individual strand.

However, cost limitations often push the design in the opposite direction. The aforementioned molding process (molding the anchor directly over the exposed strands) can be quite cheap, but will not produce an efficient termination. The compound needed for molding the anchor is ill-suited to potting synthetic cable strands. This is true for several reasons, including: (1) Synthetic cable strands are often quite fine (on the order of a human hair), which dictates the use of a molding compound having low viscosity; (2) Synthetic cable strands are not very heat-resistant; and (3) Synthetic cable strands are very slick, requiring a molding compound with good mechanical adhesion. Thus, while the molding approach allows a low production cost, it has not traditionally been able to produce an efficient termination. A process which allows the use of a molding process, yet retains the efficiency of a traditional potting process, is therefore desirable.

### BRIEF SUMMARY OF THE PRESENT INVENTION

The present invention employs a potting process to efficiently attach a cable's strands to a shell. A molding process is then used to mold a completed anchor over the shell (or otherwise attach the anchor to the shell), thereby forming a completed termination. Devices for carrying out the proposed process are also described.

The shell material and potting compound used to lock the strands to the shell are selected to obtain the maximum strength for the strand-to-shell attachment. A second material is then used to create the molded balance of the termination, with this second material being selected for its suitability for molding and for forming strong mechanical features such as threads, eyes, or hooks.

In some embodiments the shell is omitted. For these versions the potting process is carried out in a first mold. The potted strands are then removed from this first mold and placed in a second mold, where molding compound is placed around the solidified potted region and allowed to harden to form a completed termination.

### BRIEF DESCRIPTION OF THE SEVERAL VIEWS OF THE DRAWINGS

FIG. 1 is a perspective view, showing a shell attached to the end of a cable.

FIG. 2 is a perspective view, showing a molded termination.

FIG. 3 is a sectional perspective view, showing a molded termination.

FIG. 4 is a perspective sectional view, showing a shell with a separate jacket shield.

FIG. 5 is a perspective view, showing an alternate embodiment of the shell.

FIG. 6 is a perspective sectional view, showing a molded termination.

FIG. 7 is a perspective sectional view, showing a molded termination.

FIG. 8 is a perspective view, showing an alternate embodiment of the shell.

FIG. 9 is a perspective sectional view, showing a molded termination.

FIG. 10 is a perspective sectional view, showing a molded termination.

FIG. 11 is a perspective view, showing a molded region of a cable.

FIG. 12 is a perspective sectional view, sowing a molded termination formed without a shell.

FIG. 13B is a perspective sectional view, showing a molded termination formed without a shell.

FIG. 13B is a perspective sectional view, showing a molded termination formed without a shell.

FIG. 14 is a perspective view, showing a molded region of a cable.

FIG. 15 is a perspective view, showing the first molding operation.

FIG. 16 is a perspective view, showing the second molding operation.

FIG. 17 is a perspective view, showing one type of mold used in the potting operation.

FIG. 18 is a perspective view, showing an alternate embodiment for the shell.

### REFERENCE NUMERALS IN THE DRAWINGS

| | | | |
|---|---|---|---|
| 10 | shell | 12 | cable |
| 14 | jacket | 16 | splayed strands |
| 18 | molded anchor | 20 | separate jacket shield |
| 22 | concave region | 24 | threaded region |
| 26 | Positioning tab | 28 | solidified potted region |
| 30 | extended portion | 32 | flow control lip |
| 34 | expanding passage | 36 | cable shield flange |
| 38 | sealing flange | 40 | first mold |
| 42 | second mold | 44 | molding collar half |
| 46 | locking sleeve | 48 | double conic shell |
| 50 | exterior conical surface | | |

### DESCRIPTION OF THE INVENTION

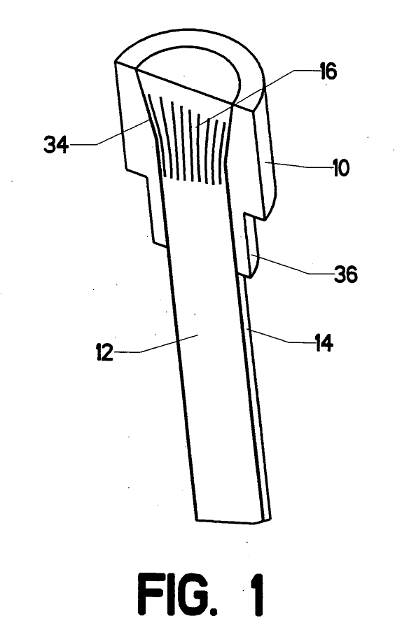

FIG. 1 is a section view showing a cable 12. Such a cable may or may not be surrounded by a jacket 14. Shell 10, as shown, is a solid piece having a vertical bore which expands from bottom to top—denoted as expanding passage 34 (This passage could be made in many shapes, the one shown being presented merely as an example). The reader should note that directional terms—such as “bottom” and “top”—refer only to the orientation of the cable in the particular view. Obviously, the cable will function in any orientation. If the assembly shown is inverted, “top” would become “bottom.”

The shell must be efficiently attached to the end of the cable. As discussed in the preceding section, a potting process can efficiently create this attachment. An exposed length of strands within expanding passage 34 is wetted with liquid potting compound (either before or after being placed within expanding passage 34). The strands are preferably splayed to fill the expanding passage's volume. A straight portion can be provided adjacent to the expanding portion (as shown in the view). Such a straight portion can aid the transition between the potted and unpotted strands. Splayed strands 16 are retained within shell 10 until the liquid potting compound hardens, thereby locking the strands to shell 10.

Once the potting compound has hardened, the shell will be firmly attached to the cable. The reader will perceive, however, that the simple shape of shell 10 is not particularly desirable for attaching the cable to anything. Cable's typically carry a tensile load, meaning that a hook, eye, threaded shaft, or similar feature is needed to attach the cable to something else.

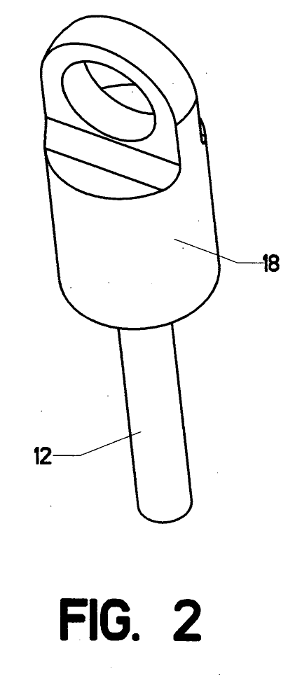

FIG. 2 shows a completed termination incorporating an “eye.” This is a useful mechanical feature whereby a bolt or pin passed through the eye can attach the cable to something else. The termination of FIG. 2 includes a molded anchor 18, which is molded directly over the shell of FIG. 1.

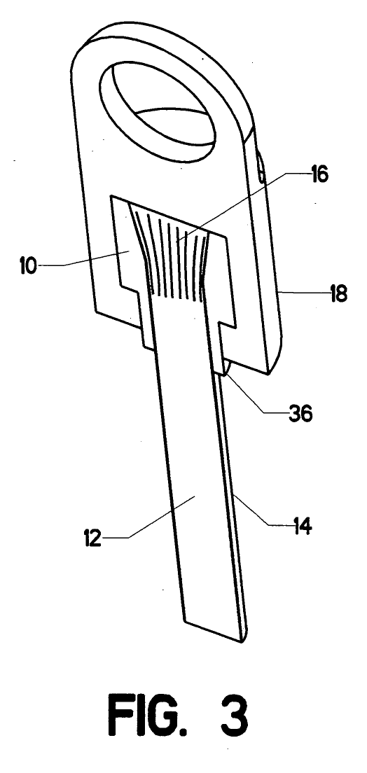

FIG. 3 is a sectional view of the same assembly. A mold was used to form a desired shape for molded anchor 18, including an attachment eye that can be used to attach the cable. In this particular example, a portion of the molded anchor lies beneath one of the outer surfaces of shell 10 so that tensile loads placed on the cable can be transmitted to molded anchor 18. The reader will note that the splayed strands within the shell are locked in place via the hardened potting compound. This creates a very efficient load carrying connection between the cable and the shell. A similarly efficient load carrying connection is made between the shell and the molded anchor, resulting in an efficient overall termination.

The addition of the molding compound over the shell may be thought of as “overmolding.” “Overmolding” means placing the solidified potted region of a cable into the cavity of a mold and filling the cavity with liquid molding compound. The molding compound then solidifies over the solidified potted region to form a unified termination. The overmolded region does not contain any cable strands, so it is not a composite structure with respect to the cable strands (although separate reinforcing strands could be added to make it another type of composite structure).

The reader will observe that shell 10 includes a descending portion denoted as cable shield flange 36. This optional feature can be included to protect the cable from the overmolding process—should protection be necessary. As an example, the molding material may be molten metal. Many cable materials are unable to withstand the molding temperature of a molten metal. Thus, the cable shield flange prevents the molding material or process from contacting and damaging jacket 14, or the cable strands themselves for cables having no jacket. Cable shield flange 36 can also provide extra gripping surface if no jacket is used.

The reader should not think of the cable shield flange as providing only thermal protection, since the overmolding process may be a low temperature one. Some molding processes involve reactive chemicals which could chemically damage the cable or jacket. The cable shield flange may therefore be designed to guard against this problem instead of simple overheating.

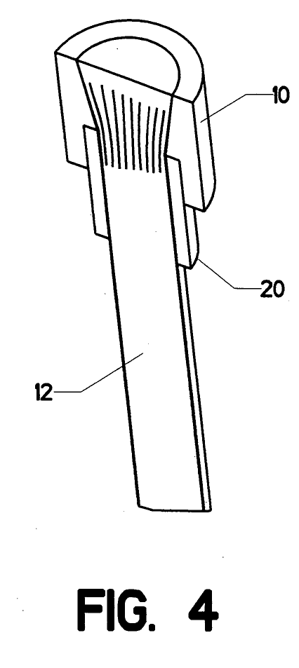

Of course, such a jacket or cable-protecting feature need not be formed integrally. FIG. 4 shows separate jacket shield 20 placed around the jacket to protect it during the molding process. Separate jacket shield 20 can be designed to remain in place or to be removed after the molding is complete. Such a separate jacket shield can also be used to protect the core strands on cables having no jacket. It could be made of many different materials using many different processes. If as an example, low thermal conductivity is desired, it could be made of ceramic.

The reader should bear in mind that overcoming the aforementioned melting temperature incompatibility is only an example of what the proposed process can accomplish. The proposed process contemplates creating a termination in stages using dissimilar materials. The process can overcome many prior art limitations other than temperature.

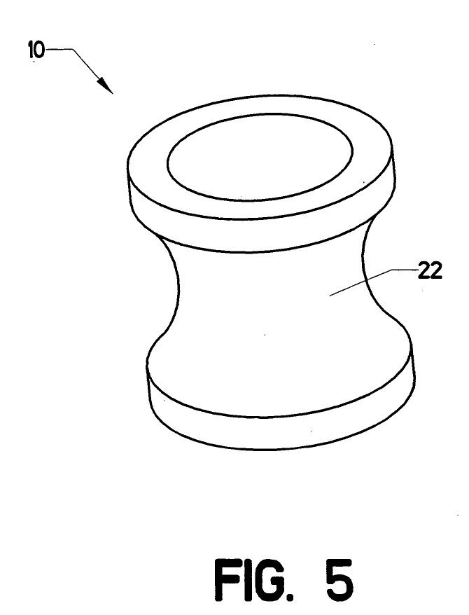

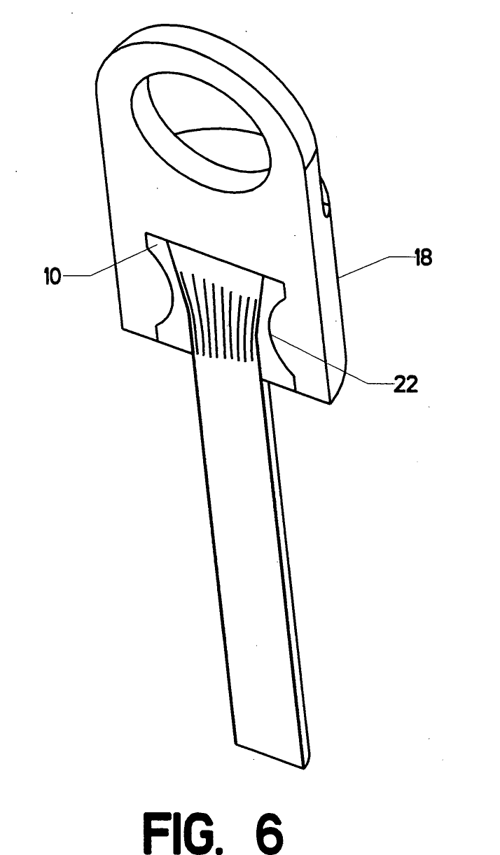

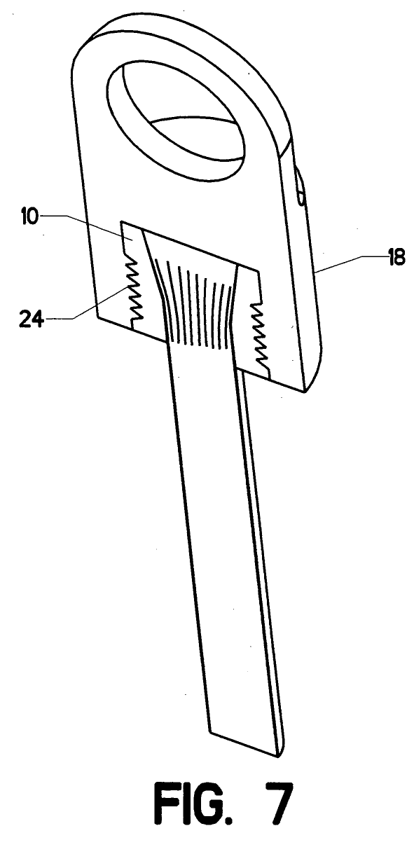

Those skilled in the art will realize that many geometric features can be used to lock shell 10 to molded anchor 18. FIG. 5 shows a shell 10 incorporating concave region 22. FIG. 6 shows this shell 10 after a molded anchor 18 has been cast around it. The molded material has flowed into and around concave region 22, thereby locking the two components together without having to enclose the lower extreme of shell 10. FIG. 7 shows another type of interlocking geometry in which shell 10 has threaded region 24. Simple serrations could also be used.

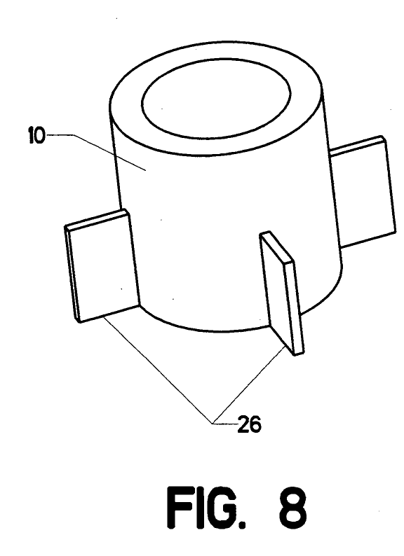

Many useful features can be incorporated into shell 10. As one example, it may be important to ensure that the shell and cable assembly is properly centered in a die casting mold before shooting in the molten metal. FIG. 8 shows a shell 10 which incorporates four positioning tabs 26 (As one example—the number and shape of the tabs could vary). The tips of these tabs make contact with the walls of the mold cavity, thereby ensuring that shell 10 is centered within the mold cavity.

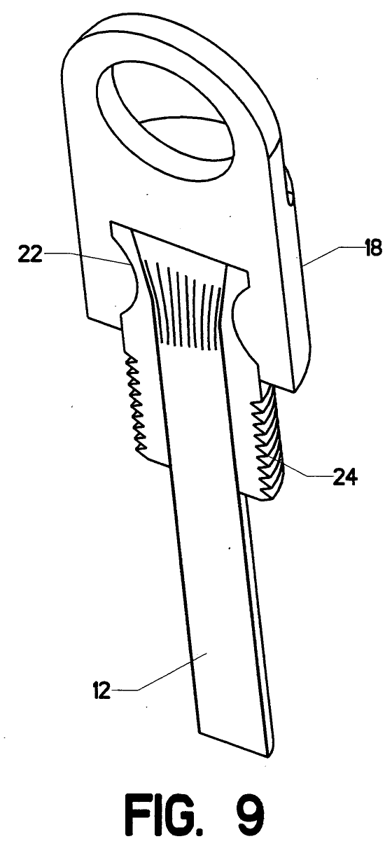

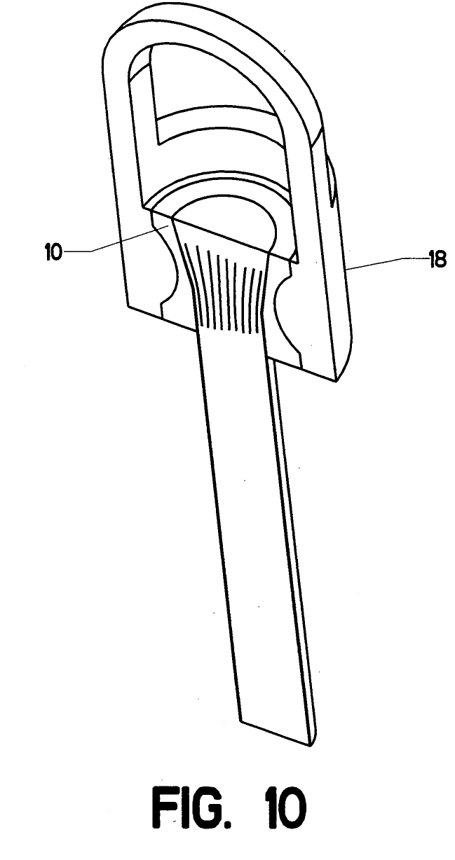

Combinations of features are also possible. FIG. 9 shows a shell 10 having concave region 22 on its upper half and threaded region 24 on its lower half. Molded termination 18 is formed around the assembly as described previously. Threaded portion 24 can then be used to thread on locking nuts or similar items. FIG. 10 shows yet another alternate embodiment for shell 10. In this configuration, molded anchor 18 does not need to touch the upper or lower surfaces of shell 10.

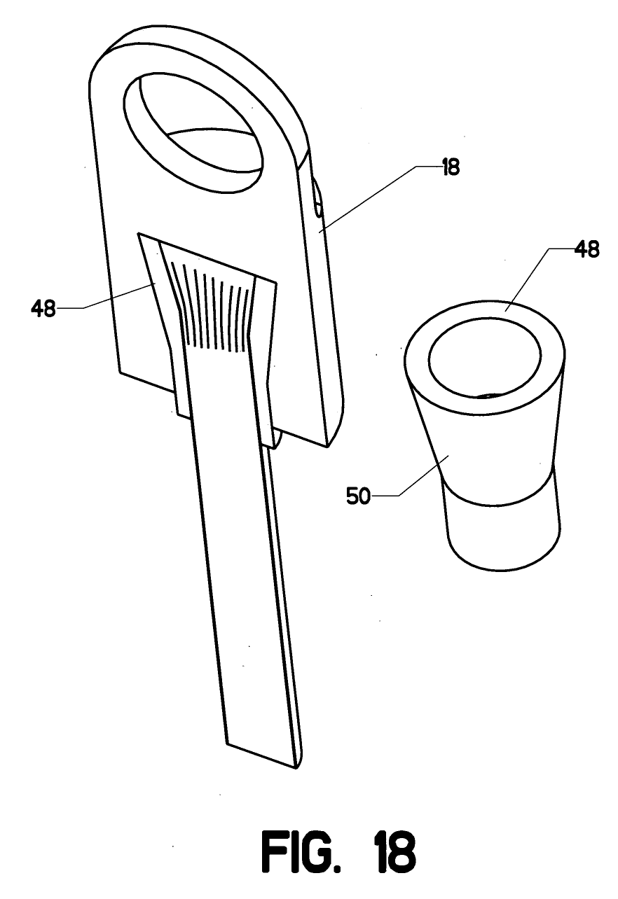

Simpler geometry can be used to effectively lock the shell to the overmolded anchor. The right hand portion of FIG. 18 shows double conic shell 48. It has an expanding conical internal passage used to pot the cable strands into the shell. It also has exterior conical surface 50. The left hand view is a sectional view of this type of shell after the anchor has been overmolded. The shell's expanding internal passage locks the potted strands in place. Likewise, the shell's expanding external surface locks molded anchor 18 to the shell (via the anchor being molded over this expanding external surface).

A simple conical shape is shown. More complex expanding shapes could be substituted. A conical expanding shape results from revolving a straight line. The more complex shapes can be produced by revolving an arc, a combination of arcs, a parabola (a second order curve), or a higher-order curve (third order or higher).

The examples shown in FIGS. 1 through 10 represent the potential use of three materials to create a termination (exclusive of the cable itself). The first is the material used to create the shell. The second is the potting compound used to lock the cable strands into the shell. The third is the molding compound used to form the molded anchor. The selection of each of the three materials can be made to facilitate a particular process, such as the selection of aluminum for the shell in order to facilitate easy machining. In some instances the same material can be used for two or more of the components.

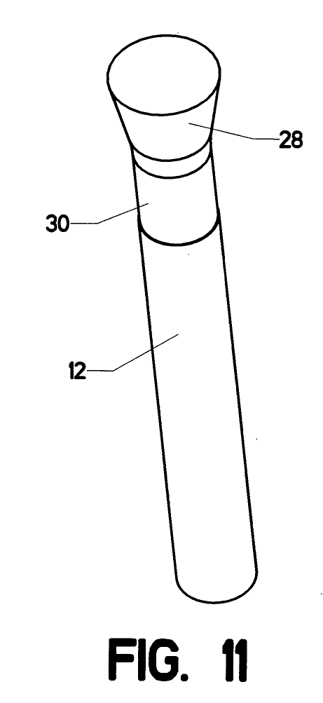

The embodiments shown in FIGS. 1 through 10 use a shell as part of the potting process. It is also possible, however, to practice another version of the process in which the shell is omitted. FIG. 11 shows a cable 12 in which the strands have been splayed, infused with liquid potting compound, and allowed to harden inside a first mold which shapes them into solidified potted region 28. The mold is designed to break apart in order to release the completed solidified potted region (such as a two-piece mold split down the middle). The mold's interior cavity is typically coated with a release agent so the potting compound does not adhere to the walls.

The mold cavity is preferably provided with an expanding portion so that the solidified potted region formed also includes an expanding portion. It may also be desirable to include extended portion 30 (a straight extension of the region of solidified potting compound) in order to further protect the cable and minimize stress in the transition between the potted and unpotted strands.

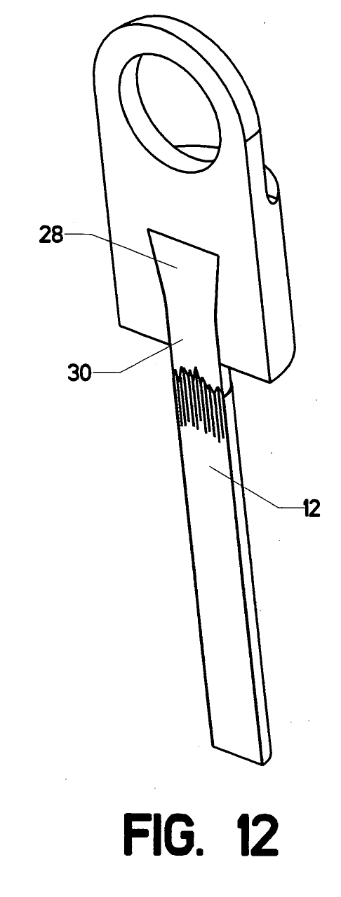

Solidified potted region 28 is then placed within a second mold and molded anchor 18 is overmolded around it. Extended portion 30 protects the cable from the second molding process if need be. It can also protect the cable from chemical reactions which may occur in a reactive molding process. FIG. 12 shows the completed assembly, where a molded anchor has been formed over the previously formed solidified potted region 28. The reader will note how the expanding portion formed in the solidified potted region locks that region to the overmolded anchor.

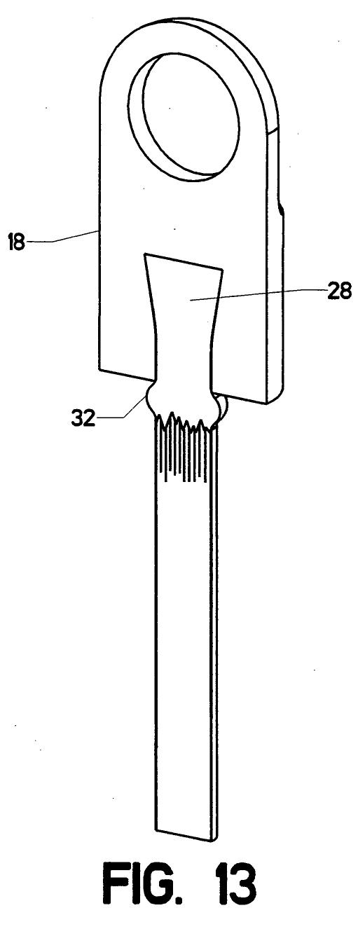

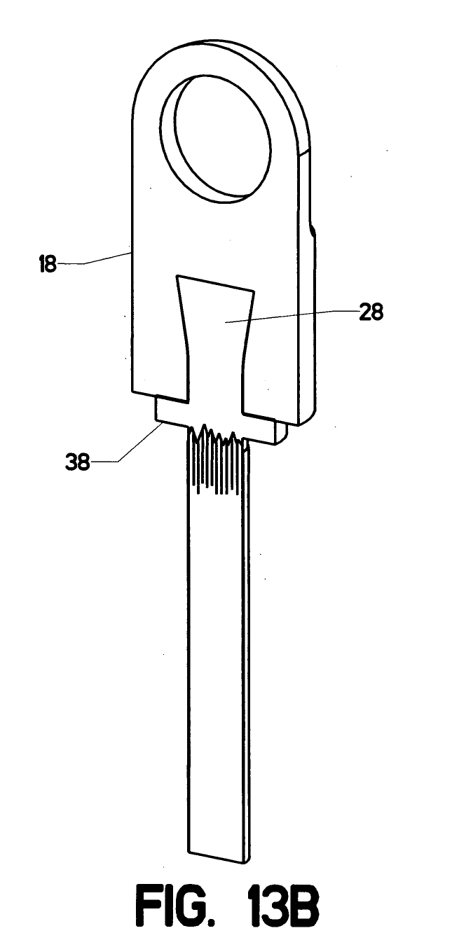

The use of the initial mold to create solidified potted region 28 allows the inclusion of many additional useful features. As an example, FIG. 13 shows the inclusion of flow control lip 32 (A recess in the first mold cavity forms this bulge in the solidified potted region). If the second mold operation uses a cross-linking polymer, flow control lip 32 can prevent the downward leakage of the liquid polymer. The lip can take on many sizes and shapes. FIG. 13B shows sealing flange 38, which provides protection over a larger surface area. Sealing flange 38 is designed to mate with and seal off the bottom portion of the mold cavity.

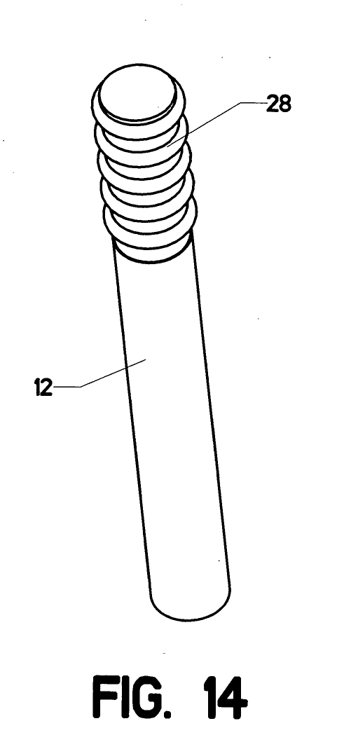

A linearly expanding cross section has been illustrated for solidified potted region 28. In general, an expanding region is most beneficial in terms of evenly distributing stress. Conical sections work, as well as arcuate, parabolic, or higher-order radially symmetric expanding section. However, virtually any type of geometry can be used, so long as it mechanically interlocks with molded anchor 18. FIG. 14 shows one such variation, in which a series of ribs have been molded into solidified potted region 28. When the second molding operation is performed, these ribs will lock the material injected in the second molding operation to solidified potted region 28.

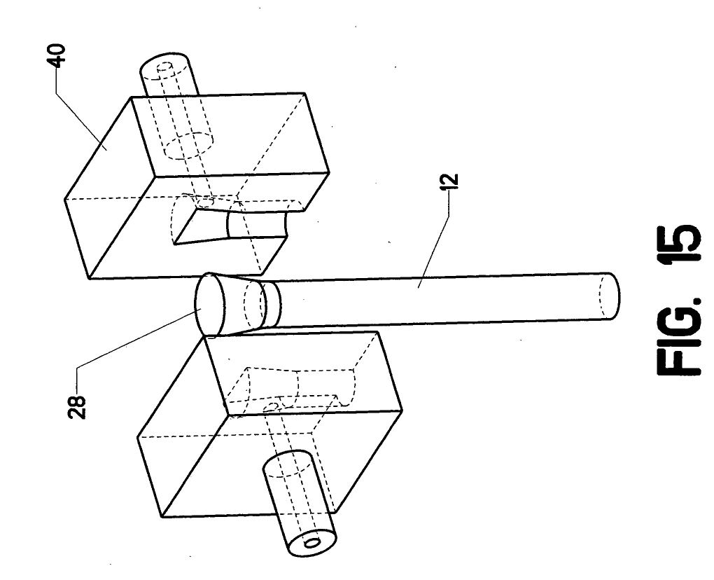

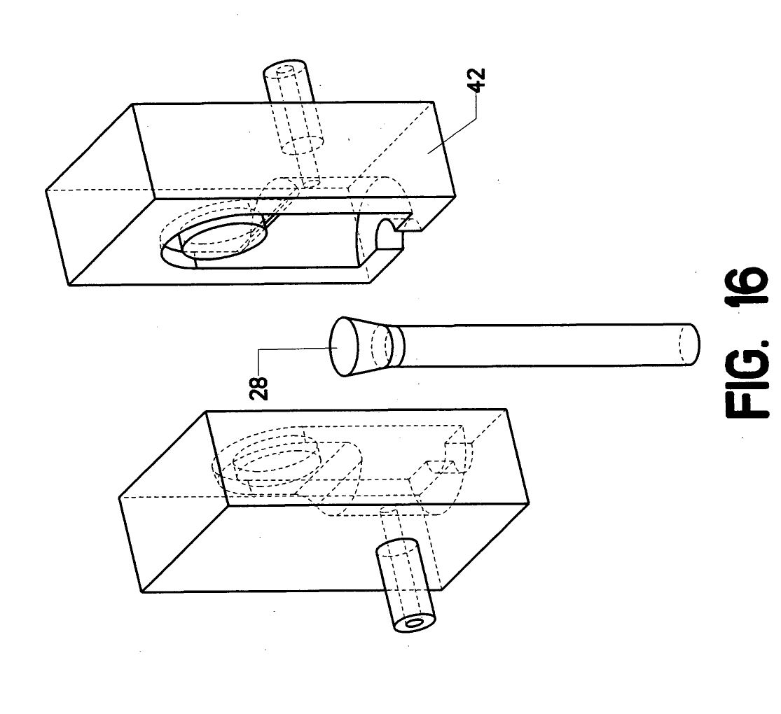

Many different types of molds can be used. FIG. 15 shows a simple two part mold designed to create solidified potted region 28 without the use of a separate shell (note the inclusion of an expanding portion and a straight portion in the mold cavity). This mold is designated as first mold 40. It is shown opening after the liquid potting compound has turned solid to form solidified potted region 28. The cable with the solidified potted region is then placed into a second mold so that the balance of the molded anchor can be “overmolded.” FIG. 16 shows second mold 42. It closes over solidified potted region 28. A second material (“molding compound”) is then injected into the cavity surrounding the solidified potted region and allowed to harden. When the mold opens, a finished termination such as shown in FIG. 12 will be produced.

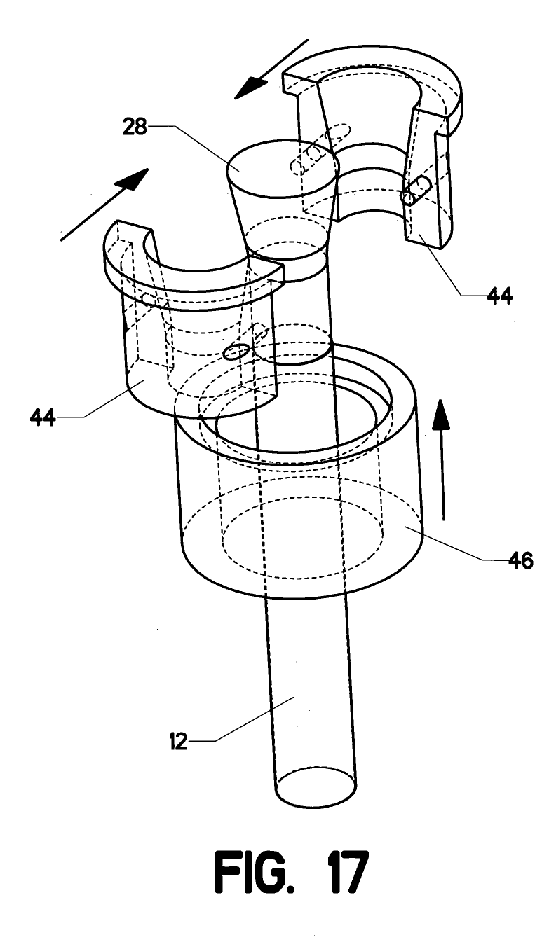

The molds employed need not be complex devices such as used in the field of injection plastic molding. Simpler versions can be employed, especially for creating the solidified potted region. FIG. 17 shows one such design. Two molding collar halves 44 are mated over the exposed strands on the end of a cable (the interlocking pins assure alignment). Locking sleeve 46 is then placed over the molding collar halves in order to retain them in position while the liquid potting compound hardens. Many other types of molds could be used.

Thus, the practice of the inventive process without the use of a separate shell can be characterized as using only two materials to create a termination (exclusive of the cable itself). The first material is used to infuse the cable strands and to harden into solidified potted region 28 within a first mold. The second material is then placed around this first material (“overmolded”) and allowed to harden within a second mold.

Of course, a particular compound could serve as both a potting compound and a molding compound. One example would be a reactive cross-linking polymer. This could be used in a potting process. Once the solidified potted region is formed, the same compound could be used to mold the balance of the anchor over the solidified potted region. The use of a single compound for both operations would rarely be desirable, but it is possible. Thus, the invention should not be viewed as being limited to the use of two separate compounds.

The reader should also bear in mind that many known techniques could be used in the overmolding process. Injection molding, resin transfer molding, and vacuum molding are additional good examples of processes which can be used to create molded anchor 18.

Although the “eye” or hoop style of termination has been used throughout the disclosure, the reader should bear in mind that any type of terminal shape or form could be used. For example, a hook, threaded stud, fork, or stop could be substituted for the hoop shown.

The terminations formed have been illustrated on the end of a cable. Those skilled in the art will realize, however, that such terminations could be formed at some intermediate point along the cable as well.

Although the preceding description contains significant detail, it should not be construed as limiting the scope of the invention but rather as providing illustrations of the preferred embodiments of the invention. Thus, the scope of the invention should be determined by the following claims rather than by the examples given.

1. A method for creating a termination affixed to a length of strands of a cable, comprising:
a. providing a shell, wherein said shell includes a passage;
b. providing a potting compound which is initially in a liquid state but which will harden into a solid state over time;
c. placing said length of strands within said passage in said shell;
d. at some point infusing said length of strands with said potting compound in said liquid state;
e. allowing said potting compound to harden into said solid state while said length of strands lie within said passage, thereby bonding said length of strands to said shell;
f. placing said length of strands and said shell into a mold; and
g. molding a molded anchor around said length of strands and said shell to form a completed termination.

2. A method as recited in claim 1, further comprising providing a mechanical interlocking feature on said shell so that when said molded anchor is molded around said shell said molded anchor will be mechanically locked to said shell.

3. A method as recited in claim 2, wherein said mechanical interlocking feature comprises a concave region.

4. A method as recited in claim 2, wherein said mechanical interlocking feature comprises an external thread.

5. A method as recited in claim 2, wherein said mechanical interlocking feature comprises a serration.

6. A method as recited in claim 1, wherein said molded anchor is molded over a portion of all the external surfaces of said shell in order to mechanically interlock with said shell.

7. A method as recited in claim 1, further comprising providing said shell with a cable shield flange positioned to prevent contact between said molded anchor and said cable.

8. A method as recited in claim 6, further comprising providing said shell with a cable shield flange positioned to prevent contact between said molded anchor and said cable.

9. A method as recited in claim 1, further comprising providing a separate cable shield flange positioned to prevent contact between said molded anchor and said cable.

10. A method as recited in claim 1, further comprising providing a separate cable shield flange positioned to prevent contact between said molded anchor and said cable.

11. A method for creating a termination affixed to a length of strands of a cable, comprising:
a. providing a potting compound which is initially in a liquid state but which will harden into a solid state over time;
b. placing said length of strands into a first mold;
c. at some point infusing said length of strands with said potting compound in said liquid state;
d. allowing said potting compound to harden into said solid state while said length of strands lie within said first mold, thereby forming a solidified potted region containing said length of strands and said hardened potting compound;
e. placing said solidified potted region into a second mold; and
f. molding a molded anchor around said solidified potted region to form a completed termination.

12. A method as recited in claim 11, further comprising providing a mechanical interlocking feature on said solidified potted region so that when said molded anchor is molded around said molded region said molded anchor will be mechanically locked to said solidified potted region.

13. A method as recited in claim 12, wherein said mechanical interlocking feature comprises a concave region.

14. A method as recited in claim 12, wherein said mechanical interlocking feature comprises an external thread.

15. A method as recited in claim 12, wherein said mechanical interlocking feature comprises a serration.

16. A method as recited in claim 11, wherein said molded anchor is molded over a portion of all the external surfaces of said solidified potted region in order to mechanically interlock with said shell.

17. A method as recited in claim 11, further comprising providing said solidified potted region with an extended portion positioned to prevent contact between said molded anchor and said cable.

18. A method as recited in claim 16, further comprising providing said solidified potted region with an extended portion positioned to prevent contact between said molded anchor and said cable.

19. A method as recited in claim 12, wherein said mechanical interlocking feature comprises a convex region.

20. A method as recited in claim 12, wherein said mechanical interlocking feature comprises a circumferential rib.

21. A method for creating a termination affixed to a length of strands of a cable, comprising:
a. providing a potting compound which is initially in a liquid state but which will harden into a solid state;
b. infusing said length of strands with said potting compound in said liquid state;
c. allowing said potting compound to harden into said solid state while said potting compound remains infused within said length of strands, thereby forming a solidified potted region;
d. providing a molding compound which is in a liquid state but which will harden into a solid state; and
e. overmolding said molding compound over said solidified potted region to form a molded anchor over said solidified potted region, thereby forming a completed termination.

22. A method as recited in claim 21, further comprising:
a. containing said liquid potting compound within a first mold as said liquid potting compound hardens;
b. wherein said first mold is shaped to form a first mechanical interlocking feature within said solidified potted region; and
c. containing said molding compound within a second mold during said overmolding, so that when said molding compound is molded over said solidified potted region said molding compound will engage said first mechanical interlocking feature, thereby bonding said molded anchor to said solidified potted region.

23. A method as recited in claim 22, wherein:
a. said solidified potted region has an exterior surface; and
b. said first mechanical interlocking feature is at least one enlarged portion on said exterior surface of said solidified potted region.

24. A method as recited in claim 22, wherein:
a. said solidified potted region is formed on an end of said cable;
b. said solidified potted region has a first end proximate said end of said cable and a second end distal to said cable;
c. said solidified potted region has an exterior surface which faces generally outward from the centerline of said cable; and
d. said first mechanical interlocking feature comprises said exterior surface assuming the form of a truncated cone having a large end and a small end, with said large end being proximate said first end of said solidified potted region.

25. A method for creating a termination affixed to a length of strands of a cable, comprising:
a. providing a shell, wherein said shell includes a passage;
b. providing a potting compound which is initially in a liquid state but which will harden into a solid state;
c. placing said length of strands within said passage in said shell;
d. at some point infusing said length of strands with said potting compound in said liquid state;
e. allowing said potting compound to harden into said solid state while said length of strands lie within said passage, thereby bonding said length of strands to said shell;
f. providing a molding compound which is in a liquid state but which will harden into a solid state;
g. placing said length of strands and said shell into a mold; and
h. overmolding said molding compound over said shell and said bonded length of strands to form a molded anchor over said shell and said bonded length of strands, thereby forming a completed termination.

26. A method as recited in claim 25, further comprising providing said shell with a first mechanical interlocking feature so that when said molding compound is molded over said shell said molding compound will engage said first mechanical interlocking feature, thereby bonding said molded anchor to said shell.

27. A method as recited in claim 26, wherein:
a. said cable has an end;
b. said length of strands of said cable is located on said end of said cable;
c. said shell has a first end and a second end;
d. said first end of said shell encloses said cable proximate said end of said cable;
e. said second end of said shell encloses said cable distal to said end of said cable; and
f. said first mechanical interlocking feature comprises an engagement surface on said second end of said shell.

28. A method as recited in claim 26, wherein:
a. said cable has an end;
b. said length of strands of said cable is located on said end of said cable;
c. said shell has a first end and a second end;
d. said first end of said shell encloses said cable proximate said end of said cable;
e. said second end of said shell encloses said cable distal to said end of said cable; and
f. said first mechanical interlocking feature comprises a recessed engagement surface between said first end and said second end of said shell.

29. A method for creating a termination affixed to a length of strands of a cable, comprising:
a. providing a shell made of a first material, wherein said shell includes an expanding passage;
b. providing a potting compound which is initially in a liquid state but which will harden into a solid state over time;
c. placing said length of strands within said expanding passage in said shell;
d. at some point infusing said length of strands with said potting compound in said liquid state;
e. allowing said potting compound to harden into said solid state while said length of strands lie within said expanding passage, thereby forming said potting compound and strands within said expanding passage into an expanding solidified potted region, thereby mechanically locking said solidified potted region to said shell;
f. placing said solidified potted region and said shell into a mold; and
g. molding a molded anchor made of a second material having properties different from said first material around said solidified potted region and said shell.

30. A method as recited in claim 29, further comprising providing a mechanical interlocking feature on said shell so that when said molded anchor is molded around said shell said molded anchor will be mechanically locked to said shell.

31. A method as recited in claim 30, wherein said mechanical interlocking feature comprises a concave region.

32. A method as recited in claim 30, wherein said mechanical interlocking feature comprises an external thread.

33. A method as recited in claim 30, wherein said mechanical interlocking feature comprises a serration.

34. A method as recited in claim 29, wherein said molded anchor is molded over a portion of all the external surfaces of said shell in order to mechanically interlock with said shell.

35. A method as recited in claim 29, further comprising providing said shell with a cable shield flange positioned to prevent contact between said molded anchor and said cable.

36. A method as recited in claim 34, further comprising providing said shell with a cable shield flange positioned to prevent contact between said molded anchor and said cable.

37. A method as recited in claim 29, further comprising providing a separate cable shield flange positioned to prevent contact between said molded anchor and said cable.

38. A method as recited in claim 29, wherein said expanding passage assumes the form of a truncated cone.

39. A method as recited in claim 29, wherein said expanding passage assumes the form of a revolved arcuate wall.

40. A method as recited in claim 29, wherein said expanding passage assumes the form of a revolved second order curve.

41. A method as recited in claim 29, wherein said expanding passage assumes the form of a revolved third order curve.

42. A method for creating a termination affixed to a length of strands on an end of a cable, comprising:
a. providing a shell, wherein said shell includes an expanding passage;
b. providing a potting compound which is initially in a liquid state but which will harden into a solid state over time;
c. placing said shell on said cable by sliding said expanding passage over said end of said cable and sliding said shell a further length along said cable;
d. infusing said length of strands with said potting compound in said liquid state;
e. sliding said shell toward said end of said cable, so that said infused length of strands comes to rest within said expanding cavity;
f. allowing said potting compound to harden into said solid state while said length of strands lie within said expanding passage, thereby forming said potting compound and strands within said expanding passage into an expanding solidified potted region, thereby mechanically locking said solidified potted region to said shell;
g. placing said solidified potted region and said shell into a mold; and
h. molding a molded anchor around said solidified potted region and said shell.

43. A method as recited in claim 42, wherein said expanding passage assumes the form of a truncated cone.

44. A method as recited in claim 42, wherein said expanding passage assumes the form of a revolved arcuate wall.

45. A method as recited in claim 42, wherein said expanding passage assumes the form of a revolved second order curve.

46. A method as recited in claim 42, wherein said expanding passage assumes the form of a revolved third order curve.

47. A method for creating a termination affixed to a length of strands proximate an end of a cable, comprising:
a. providing a shell having a first end and a second end, wherein said shell includes a passage extending from said first end to said second end, including,
i. an expanding portion proximate said second end of said shell,
ii. a straight portion proximate said first end of said shell;
b. providing a potting compound which is initially in a liquid state but which will harden into a solid state over time;
c. placing said length of strands within said expanding portion of said passage in said shell;
d. at some point infusing said length of strands with said potting compound in said liquid state;
e. allowing said potting compound to harden into said solid state while said length of strands lie within said expanding portion of said passage, thereby forming said potting compound and strands within said expanding portion into an expanding solidified potted region, thereby mechanically locking said solidified potted region to said shell;
f. placing said solidified potted region and said shell into a mold; and
g. molding a molded anchor around said solidified potted region and said shell.

48. A method as recited in claim 47, wherein said expanding portion of said passage assumes the form of a truncated cone.

49. A method as recited in claim 47, wherein said expanding portion of said passage assumes the form of a revolved arcuate wall.

50. A method as recited in claim 47, wherein said expanding portion of said passage assumes the form of a revolved second order curve.

51. A method as recited in claim 47, wherein said expanding portion of said passage assumes the form of a revolved third order curve.

52. A method for creating a termination affixed to a length of strands of a cable, comprising:
a. providing a potting compound which is initially in a liquid state but which will harden into a solid state over time;
b. placing said length of strands into a first mold having a cavity with an expanding portion;
c. at some point infusing said length of strands with said potting compound in said liquid state;
d. allowing said potting compound to harden into said solid state while said length of strands lie within said first mold, thereby forming a solidified potted region containing said length of strands and said hardened potting compound, wherein said solidified potted region includes an expanding portion;
e. placing said solidified potted region into a second mold; and
f. molding a molded anchor around said solidified potted region to form a completed.

53. A method as recited in claim 52, wherein said expanding portion of said cavity assumes the form of a truncated cone.

54. A method as recited in claim 52, wherein said expanding portion of said cavity assumes the form of a revolved arcuate wall.

55. A method as recited in claim 52, wherein said expanding portion of said cavity assumes the form of a revolved second order curve.

56. A method as recited in claim 52, wherein said expanding portion of said cavity assumes the form of a revolved third order curve.

57. A method for creating a termination affixed to a length of strands of a cable, comprising:
a. providing a potting compound which is initially in a liquid state but which will harden into a solid state over time;
b. placing said length of strands into a first mold having a cavity with a straight portion and an expanding portion;
c. at some point infusing said length of strands with said potting compound in said liquid state;
d. allowing said potting compound to harden into said solid state while said length of strands lie within said first mold, thereby forming a solidified potted region containing said length of strands and said hardened potting compound, wherein said solidified potted region includes a straight portion and an expanding portion;
e. placing said solidified potted region into a second mold; and
f. molding a molded anchor around said solidified potted region to form a completed termination.

58. A method as recited in claim 57, wherein said expanding portion of said cavity assumes the form of a truncated cone.

59. A method as recited in claim 57, wherein said expanding portion of said cavity assumes the form of a revolved arcuate wall.

60. A method as recited in claim 57, wherein said expanding portion of said cavity assumes the form of a revolved second order curve.

61. A method as recited in claim 57, wherein said expanding portion of said cavity assumes the form of a revolved third order curve.
